(19) United States
(12) Patent Application Publication
(10) Pub. No.: US 2015/0282486 A1
(43) Pub. Date: Oct. 8, 2015

(54) RICE SEED TREATMENT COMPOSITION

(71) Applicant: SYNGENTA PARTICIPATIONS AG, Basel (CH)

(72) Inventor: Doreen Heath, Greensboro, NC (US)

(73) Assignee: SYNGENTA PARTICIPATIONS AG, Basel (CH)

(21) Appl. No.: 14/669,078

(22) Filed: Mar. 26, 2015

Related U.S. Application Data
(60) Provisional application No. 61/974,529, filed on Apr. 3, 2014.
(60) Provisional application No. 61/973,894, filed on Apr. 2, 2014.

(51) Int. Cl. A01N 55/02

(52) U.S. Cl. CPC A01N 55/02

(57) ABSTRACT

A rice seed treatment composition can comprise ZnEDTA. Methods of improving rice growing characteristics can involve treating rice seeds with ZnEDTA.

This application claims priority benefit to U.S. Provisional Patent Application 61/973,894 filed Apr. 2, 2014 and U.S. Provisional Patent Application 61/974,529 filed Apr. 3, 2014, the contents of all of which are incorporated herein by reference.

### FIELD OF THE INVENTION

The present invention relates to compositions rice seed treatment. More specifically the invention relates to compositions for treating rice seed grown in zinc-deficient conditions.

### BACKGROUND OF THE INVENTION

All crop plants require certain fundamental components for growth, but many areas where it is desirable to grow crops have shortcomings. By developing technologies to compensate for insufficient or missing natural components, flexibility increases regarding which crops are grown and where they are grown. For example, crops with moderate to high moisture requirements can grow in arid climates if irrigation is provided. Enhancements need not always be on a permanent basis, though. Where one crop has depleted a certain soil nutrient during a growing season, in the subsequent season that nutrient can be supplemented to reinstate the natural or optimum levels available to the new season's crop.

Regarding rice, a challenge when striving for optimum production is to ensure sufficient zinc is available to the plant. A rate of about 3-20 ppm can be sufficient. But some areas where rice is grown have soil which is naturally low or deficient in zinc. In other cases, due to crop rotation or environmental factors, there is a temporary lower level of zinc available to the rice plants. By offering supplemental zinc to the plant or growing media the maximum crop growth and yield potential can be achieved.

Commercially available zinc products for rice are typically applied to the soil or to the growing plant as a foliar application. However under some circumstances it can be preferred to provide the zinc directly on the rice seed. Zinc oxide (ZnO) or Zinc sulfate (ZnSO₄) are known for this purpose.

Ethylenediaminetetraacetic acid (EDTA) is a chelating agent, which readily binds to metal ions and can be used to keep divalent or polyvalent metals ions in solutions. In agriculture the chelate with zinc, ZnEDTA is known to be mixed with other nutrients and/or fertilizers and applied as part of a drip irrigation system (CN 102964163) or via foliar application (CN 101391927).

Slaton et al disclose the application of ZnEDTA to rice seed and recommend between 2.2 and 5.8 g Zn/kg of rice seed as an economical alternative to soil-applied zinc. In their trials 1.4 g ZnEDTA/kg rice seed was not successful (Evaluation of Zinc Seed Treatments for Rice, Agron. J. 93(1):152-157 (2001)).

Despite the existing technologies, there remains a need in the art for improved compositions to provide optimum zinc levels to rice plants.

### SUMMARY OF THE INVENTION

It is therefore an object of the present invention to provide an improved zinc-containing rice seed treatment composition. Methods to improve rice growth using the composition are also provided.

The present invention surprisingly provides zinc as a micronutrient in the form of ZnEDTA at very low levels compared with commercial standards and the teachings of the prior art. This can help prevent unnecessary excess of zinc in the environment, and prevent unnecessary costs associated with overuse of zinc.

In a first aspect, the present invention provides a rice seed treatment composition comprising zinc in the form of zinc ethylenediaminetetraacetic acid, wherein the composition is applied to rice seed at a rate of 1-2 g Zn/kg rice seed, excepted is a rate of 1.40 g Zn/kg rice seed. The seed treatment composition can be applied to rice seed at a rate of 1.10-1.90 g Zn/kg rice seed, preferably 1.20-1.80 g Zn/kg rice seed, most preferably 1.3-1.7 g Zn/kg rice seed. The composition can further comprise a pesticidal active ingredient, for example thiamethoxam, clothianidin, imidacloprid, acetamiprid, dinotefuran, nitenpyram, thiacloprid, thiodicarb, aldicarb, carbofuran, furadan, fenoxycarb, carbaryl, sevin, ethienocarb, fenobucarb, chlorantraniliprole, cyantraniliprole, flubendiamide, spinosad, spinetoram, lambda-cyhalothrin, gamma-cyhalothrin, tefluthrin, fipronil, sulfoxaflor, azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M, sedaxane, penflufen, abamectin, aldicarb, thiadicarb, carbofuran, carbosulfan, oxamyl, aldoxycarb, ethoprop, methomyl, benomyl, alanycarb, iprodione, phenamiphos (fenamiphos), fensulfothion, terbufos, fosthiazate, dimethoate, phosphocarb, dichlofenthion, isamidofos, fosthietan, isazofos ethoprophos, cadusafos, terbufos, chlorpyrifos, dichlofenthion, heterophos, isamidofos, mecarphon, phorate, thionazin, triazophos, diamidafos, fosthietan, phosphamidon, imicyafos, captan, thiophanate-methyl and/or thiabendazole.

In another aspect, the invention provides a method of improving the growing characteristics of rice which comprises applying ZnEDTA to rice seeds at a rate of 1-2 g Zn/kg rice seed and sowing the seeds, wherein the rate is not 1.40 g Zn/kg rice seed. The seeds can be sown in zinc-deficient soil. At least one pesticidal active ingredient could be applied to the rice seeds prior to the sowing step. Examples of suitable pesticidal agents include thiamethoxam, clothianidin, imidacloprid, acetamiprid, dinotefuran, nitenpyram, thiacloprid, thiodicarb, aldicarb, carbofuran, furadan, fenoxycarb, carbaryl, sevin, ethienocarb, fenobucarb, chlorantraniliprole, cyantraniliprole, flubendiamide, spinosad, spinetoram, lambda-cyhalothrin, gamma-cyhalothrin, tefluthrin, fipronil, sulfoxaflor, azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M, sedaxane, penflufen, abamectin, aldicarb, thiadicarb, carbofuran, carbosulfan, oxamyl, aldoxycarb, ethoprop, methomyl, benomyl, alanycarb, iprodione, phenamiphos (fenamiphos), fensulfothion, terbufos, fosthiazate, dimethoate, phosphocarb, dichlofenthion, isamidofos, fosthietan, isazofos ethoprophos, cadusafos, terbufos, chlorpyrifos, dichlofenthion, heterophos, isamidofos, mecarphon, phorate, thionazin, triazophos, diamidafos, fosthietan, phosphamidon, imicyafos, captan, thiophanate-methyl and thiabendazole.

In another aspect, the invention provides a rice seed comprising ZnEDTA at a rate of from 1 to 2 g Zn/kg rice seed, wherein the rate is not 1.40 g Zn/kg rice seed. The rice seed may further comprise thiamethoxam, fludioxonil, azoxystrobin, metalaxyl-M and/or sedaxane.

As used herein “rice” refers to the cereals scientifically classified as rice such as Oryza glaberrima, O. nivara, O. rufipogon and O. sativa and also plants which are commonly referred to as rice for example Zizania spp.

The rice discussed herein is to be understood as being those crops which are naturally occurring, obtained by conventional methods of breeding, or obtained by genetic engineering. They include crops which contain so-called output traits (e.g. improved storage stability, higher nutritional value and improved flavour).

Rice crops are to be understood as also including those crops which have been rendered tolerant to herbicides like bromoxynil or classes of herbicides such as ALS-, EPSPS-, GS-, HPPD- and PPO-inhibitors. Crops are also to be understood as being those which naturally are or have been rendered resistant to harmful insects. This includes plants transformed by the use of recombinant DNA techniques, for example, to be capable of synthesising one or more selectively acting toxins, such as are known, for example, from toxin-producing bacteria. Examples of toxins which can be expressed include δ-endotoxins, vegetative insecticidal proteins (Vip), insecticidal proteins of bacteria colonising nematodes, and toxins produced by scorpions, arachnids, wasps and fungi. Crops or seed material thereof can also be resistant to multiple types of pests (so-called stacked transgenic events when created by genetic modification). For example, a plant can have the ability to express an insecticidal protein while at the same time being herbicide tolerant.

As used herein, the term “seed” refers to any suitable plant propagation material and specifically includes seeds in the strict sense as well as vegetative material of plants such as synthetic seeds created using tissue culture.

As used herein, ‘improving the growth’ can mean for example an increase in germination, more consistent germination, increase in yield, improvement in plant vigour, and/or an improvement in plant quality.

The term “increase in yield” means that the yield of a product of the plant is increased by a measurable amount over the yield of the same product of the plant produced under the same conditions, but without the application of the composition according to the present invention. It is preferred that the yield is increased by at least about 1%, preferably 2%, more preferably 3%, yet more preferably 4% or more. Even more preferred is an increase in yield of at least about 5%, 10%, 15% or 20% or more.

As used herein, an ‘improvement in plant vigour’ means that certain traits are improved qualitatively or quantitatively when compared with the same trait in a control plant which has been grown under the same conditions in the absence of the method of the invention. Such traits include, but are not limited to, early and/or improved germination, improved emergence, the ability to use less seeds, increased root growth, a more developed root system, increased root nodulation, increased shoot growth, increased tillering, stronger tillers, more productive tillers, increased or improved plant stand, less plant verse (lodging), an increase and/or improvement in plant height, an increase in plant weight (fresh or dry), bigger leaf blades, greener leaf colour, increased pigment content, increased photosynthetic activity, earlier flowering, longer panicles, early grain maturity, increased seed, fruit or pod size, increased pod or ear number, increased seed number per pod or ear, increased seed mass, enhanced seed filling, less dead basal leaves, delay of senescence, improved vitality of the plant, increased levels of amino acids in storage tissues and/or less inputs needed (e.g. less fertiliser, water and/or labour needed). A plant with improved vigour may have an increase in any of the aforementioned traits or any combination or two or more of the aforementioned traits.

As used herein, an ‘improvement in plant quality’ means that certain traits are improved qualitatively or quantitatively when compared with the same trait in a control plant which has been grown under the same conditions in the absence of the method of the invention. Such traits include, but are not limited to, improved visual appearance of the plant, improved quality of harvested material (such improved quality may manifest as improved visual appearance of the harvested material), improved carbohydrate content (e.g. increased quantities of sugar and/or starch, improved sugar acid ratio, reduction of reducing sugars, increased rate of development of sugar), improved protein content, improved nutritional value, reduction in anti-nutritional compounds, improved organoleptic properties (e.g. improved taste) and/or improved consumer health benefits (e.g. increased levels of vitamins and anti-oxidants)), improved post-harvest characteristics (e.g. enhanced shelf-life and/or storage stability, easier processability, easier extraction of compounds), more homogenous crop development (e.g. synchronised germination, flowering and/or fruiting of plants), and/or improved seed quality (e.g. for use in following seasons). A plant with improved quality may have an increase in any of the aforementioned traits or any combination or two or more of the aforementioned traits.

### DETAILED DESCRIPTION OF THE INVENTION

Although the breakthrough of the present invention is to provide an improved rice seed treatment composition for increasing available zinc to the rice plant, it will be appreciated by skilled persons that the composition may be used individually or in combination with other agents appropriate for use as a rice seed treatment.

Rice seeds treated with the composition of the invention may further include an agrochemical applied simultaneously or separately. Such agrochemicals can include fungicides, insecticides, bactericides, acaricides, nematicides, nutrients, fertilizers, and/or plant growth regulators. These agents may be provided as formulations comprising, inter alia, carriers, surfactants or application promoting adjuvants customarily employed in the art of formulation. The present invention is also suitable for use with other agrochemicals such as primers and safeners.

Examples of suitable agrochemicals include the following:

Insecticides such as benzoylureas, carbamates, chloronicotinyls, diacylhydrazines, diamides, fiproles, macrolides, neonicotinoids, nitroimines, nitromethylenes, organochlorines, organophosphates, organosilicons, organotins, phenylpyrazoles, phosphoric esters, pyrethroids, spinosyns, tetramic acid derivatives and tetronic acid derivatives.

Specific examples of preferred insecticides include thiamethoxam, clothianidin, imidacloprid, acetamiprid, dinotefuran, nitenpyram, thiacloprid, thiodicarb, aldicarb, carbofuran, furadan, fenoxycarb, carbaryl, sevin, ethienocarb, fenobucarb, chlorantraniliprole, cyantraniliprole, flubendiamide, spinosad, spinetoram, lambda-cyhalothrin, gamma-cyhalothrin, tefluthrin, fipronil, and sulfoxaflor.

Fungicides such as acycloamino acid fungicides, aliphatic nitrogen fungicides, amide fungicides, anilide fungicides, antibiotic fungicides, aromatic fungicides, arsenical fungicides, aryl phenyl ketone fungicides, benzamide fungicides, benzanilide fungicides, benzimidazole fungicides, benzothiazole fungicides, botanical fungicides, bridged diphenyl fungicides, carbamate fungicides, carbanilate fungicides, conazole fungicides, copper fungicides, dicarboximide fungicides, dinitrophenol fungicides, dithiocarbamate fungicides, dithiolane fungicides, furamide fungicides, furanilide fungicides, hydrazide fungicides, imidazole fungicides, mercury fungicides, morpholine fungicides, organophosphorous fungicides, organotin fungicides, oxathiin fungicides, oxazole fungicides, phenylsulfamide fungicides, polysulfide fungicides, pyrazole fungicides, pyridine fungicides, pyrimidine fungicides, pyrrole fungicides, quaternary ammonium fungicides, quinoline fungicides, quinone fungicides, quinoxaline fungicides, strobilurin fungicides, sulfonanilide fungicides, thiadiazole fungicides, thiazole fungicides, thiazolidine fungicides, thiocarbamate fungicides, thiophene fungicides, triazine fungicides, triazole fungicides, triazolopyrimidine fungicides, urea fungicides, valinamide fungicides, and zinc fungicides.

Specific examples of preferred fungicides include azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (also known as mefenoxam), sedaxane, and penflufen.

Nematicides such as antibiotic nematicides, avermectin nematicides, botanical nematicides, carbamate nematicides, oxime carbamate nematicides, and organophosphorus nematicides.

Specific examples of preferred nematicides include abamectin, aldicarb, thiadicarb, carbofuran, carbosulfan, oxamyl, aldoxycarb, ethoprop, methomyl, benomyl, alanycarb, iprodione, phenamiphos (fenamiphos), fensulfothion, terbufos, fosthiazate, dimethoate, phosphocarb, dichlofenthion, isamidofos, fosthietan, isazofos ethoprophos, cadusafos, terbufos, chlorpyrifos, dichlofenthion, heterophos, isamidofos, mecarphon, phorate, thionazin, triazophos, diamidafos, fosthietan, phosphamidon, imicyafos, captan, thiophanate-methyl and thiabendazole.

Nematicidally active biological agents include any biological agent that has nematicidal activity and could be used with the present invention. The biological agent can be any type known in the art including bacteria and fungi. The wording “nematicidally active” refers to having an effect on, such as reduction in damage caused by, agricultural-related nematodes. Examples of nematicidally active biological agents include Bacillus firmus, B. cereus, B. subtilis, Pasteuria penetrans, P. nishizawae, P. ramosa, P. thornei, and P. usgae. A suitable Bacillus firmus strain is strain CNCM 1-1582 which is commercially available as BIONEM. A suitable Bacillus cereus strain is strain CNCM 1-1562. Of both Bacillus strains more details can be found in U.S. Pat. No. 6,406,690.

Agrochemicals referred to herein using their common name are known, for example, from “The Pesticide Manual”, 15th Ed., British Crop Protection Council 2009.

As noted above the agrochemicals of the invention may be provided in the form of formulated products. There can be many purposes for doing so, and for each a different component might be added. For example, it might be desired to protect rice seed during storage and transport from any toxicity issues associated with close physical proximity to an agrochemical. Many other purposes and solutions will be apparent to the skilled person.

Other additives which are used with seeds may advantageously be provided in conjunction with the present invention. Such additives include, but are not limited to, uv-protectants, colorants, brighteners, pigments, dyes, extenders, dispersing agents, excipients, anti-freeze agents, herbicidal safeners, seed safeners, seed conditioners, micronutrients, fertilizers, surfactants, sequestering agents, plasticizers, polymers, emulsifiers, flow agents, coalescing agents, defoaming agents, humectants, thickeners, and waxes. Such additives are commercially available and known in the art.

Methods for applying or treating active ingredients on to plant propagation material are known in the art and include dressing, coating, pelleting and soaking application methods. Conventional treating techniques and machines can be used, such as fluidized beds, roller mills, rotostatic seed treaters, drum coaters, and spouted beds. Also, using commercially available equipment (Van der Ende PHYTO-DRIP BV, NL) it is possible to perform a precise seed soaking application at the time of planting.

Examples of seed treatment formulation types for pre-mix compositions include:

WS: wettable powders for seed treatment slurry
LS: solution for seed treatment
ES: emulsions for seed treatment
FS: suspension concentrate for seed treatment
WG: water dispersible granules, and
CS: aqueous capsule suspension.

The Examples which follow serve to illustrate the invention.

### Formulation Examples

| Powders for dry seed treatment | a) | b) | c) |
|---|---|---|---|
| active ingredients | 25% | 50% | 75% |
| light mineral oil | 5% | 5% | 5% |
| highly dispersed silicic acid | 5% | 5% | — |
| Kaolin | 65% | 40% | — |
| Talcum | — | | 20 |

The combination is thoroughly mixed with the adjuvants and the mixture is thoroughly ground in a suitable mill, affording powders that can be used directly for seed treatment.

| Dusts | a) | b) | c) |
|---|---|---|---|
| Active ingredients | 5% | 6% | 4% |
| Talcum | 95% | — | — |
| Kaolin | — | 94% | — |
| mineral filler | — | — | 96% |

Ready-for-use dusts are obtained by mixing the combination with the carrier and grinding the mixture in a suitable mill. Such powders can be used for dry dressings for seed.

### Suspension Concentrate

| | |
|---|---|
| active ingredients | 40% |
| propylene glycol | 10% |
| nonylphenol polyethylene glycol ether (15 mol of ethylene oxide) | 6% |
| Sodium lignosulfonate | 10% |
| Carboxymethylcellulose | 1% |
| silicone oil (in the form of a 75% emulsion in water) | 1% |
| Water | 32% |

The finely ground combination is mixed with the adjuvants, giving a suspension concentrate from which suspensions of any desired dilution can be obtained by dilution with e.g. water. Using such dilutions, seeds can be treated by spraying, pouring or immersion.

### Flowable Concentrate for Seed Treatment

| | |
|---|---|
| active ingredients | 40% |
| propylene glycol | 5% |
| copolymer butanol PO/EO | 2% |
| Tristyrenephenole with 10-20 moles EO | 2% |
| 1,2-benzisothiazolin-3-one (in the form of a 20% solution | 0.5% |
| in water) | |
| monoazo-pigment calcium salt | 5% |
| Silicone oil (in the form of a 75% emulsion in water) | 0.2% |
| Water | 45.3% |

The finely ground combination is mixed with the adjuvants, giving a flowable concentrate from which suspensions of any desired dilution can be obtained by dilution with e.g. water. Using such dilutions, seeds can be treated by spraying, pouring or immersion.

### Biological Example

### Evaluation of Benefits of Inventive Composition

In order to evaluate advantages of the inventive composition versus known technologies, an in-vivo evaluation was performed involving treatments with three different forms of zinc on rice seed.

For the inventive composition, ZnEDTA (in the form of Dissolvine E-Zn-15 having 3% free zinc, Akzo Nobel, IL., USA) was applied as a 20% w/w aqueous solution at rates of 1.18 1.47 and 1.76 g ZnEDTA/kg seed. This was accomplished by using 8, 10 or 12 fl oz per cwt.

For the first comparative composition, ZnSO₄ was applied as a 24.7% solution at a rate of 1.90 g ZnSO₄/kg seed (in the form of ZINC PLUS having 10% free zinc, DeltAg, MS, USA). This was accomplished by using 10 fl oz per cwt.

For the second comparative composition, ZnO was applied as a 32.50% aqueous suspension at a rate of 2.00 g ZnO/kg seed (in the form of ZINCHE ST having 26% free zinc, Drexel Chemical Co, TN, USA). This was accomplished by using 8 fl oz per cwt.

To ensure pest and disease pressure did not affect the results, the seeds from all test groups were also treated with a conventional insecticide and fungicide mixture. This was done by preparing a mixture of each zinc-containing compound with the insecticide/fungicide mixture and adding water to make a total of 25 fl oz per ctw (thiamethoxam at 1.80 g/kg seed, fludioxonil at 0.015 g/kg seed, azoxystrobin at 0.07 g/kg seed, metalaxyl-M at 0.09 g/kg seed and sedaxane at 0.01 g/kg seed; commercial products available as e.g. CRUISER MAXX and VIBRANCE, both Syngenta Crop Protection, NC, USA). Also evaluated were untreated control and seeds having only the conventional insecticide and fungicide treatment.

For all test groups, one (1) kg batches of rice seed variety CL 151 (Clearfield Seed, Horizon Ag, TN, USA) were treated on a Hege seed treater (Wintersteiger AG, Austria) using a standard protocol. The seeds were allowed to dry.

Standard commercial greenhouse containers, 10 cm diameter by 9 cm deep, were filled with 350 cc of a rooting media mix consisting of 33% (v/v) Zn deficient soil collected in Arkansas, USA and then sterilized in an autoclave and 66% (v/v) commercial planting mix (NB peat, Fafard, MA, USA). Analysis of the potting mix confirmed that the zinc levels were low, at 1.97 ppm and pH levels were <7.

Prior to planting the soil was moistened with 200 ml tap water per pot. Eight seeds were sown per pot by placing them on soil surface then lightly covering with 0.5 cm of loose peat. Each treatment group had six replicates. Pots were transferred to greenhouse and maintained at 30/24° C. day/night temperature with 16 hours of supplemental high pressure sodium light. All pots were lightly watered manually every 2 to 3 days to prevent dehydration of the germination zone.

Ten days after planting (10 DAP) a drip irrigation emitter was installed on each pot. The irrigation system was set to deliver 100 ml of tap water each morning and again each evening. Germination rates were recorded and at 11 DAP rice seedlings were thinned to 5 plants per pot. By 17 DAP rice plants were in the V3 growth stage. At 18 DAP nitrogen fertilizer (urea) was added to the irrigation water at 200 ppm for the duration of trial. At 22 DAP rice plants were in the V4 growth stage with first tiller forming.

At 29 DAP rice plants were in the V5 growth stage with 3 tillers. The above ground plant tissue was harvested and placed in paper bags. Bags were placed in an oven set at 100° C. for 72 hours to dry. The dry tissue was removed from the bags and weighed. Samples of the dry tissue were analyzed for total zinc uptake (MicroMacro International, Inc. Labs, GA, USA). The procedure used for drying was the Association of Official Agricultural Chemists (AOAC) procedure 922.02, that for the ash was AOAC procedure 930.05 and the analytical method was US EPA procedure 6010C. Results are shown in Table 1 below.

TABLE 1
Trial results

| Treatment | | | |
|---|---|---|---|
| (g Zn complex/kg seed) | | Germination rate (%) | Zinc uptake (ppm) |
| Untreated | 0 | 42 | 242.27 |
| Insecticide and | 0 | Not recorded | 250.33 |
| fungicide only | | | |
| ZnEDTA | 1.18 | Not recorded | 275.47 |
| | 1.47 | 45 | 304.74 |
| | 1.76 | Not recorded | 316.00 |
| ZnSO₄ | 1.90 | 43 | 237.50 |
| ZnO | 2.00 | 42 | 253.65 |

As is evident from the data, seeds treated with the inventive composition showed improved zinc update as compared to conventional products. This lead to improved germination and it is expected if the trial was allowed to run to harvest, an increased yield.

Although the foregoing invention has been described in some detail by way of illustration and example for purposes of clarity of understanding, it will be obvious that certain changes and modifications may be practiced within the scope of the present invention.

1. A rice seed treatment composition, comprising zinc in the form of zinc ethylenediaminetetraacetic acid, wherein the composition is applied to rice seed at a rate of 1-2 g Zn/kg rice seed, excepted is a rate of 1.40 g Zn/kg rice seed.

2. A composition according to claim 1 wherein the seed treatment composition is applied to rice seed at a rate of 1.10-1.90 g Zn/kg rice seed, preferably 1.20-1.80 g Zn/kg rice seed, most preferably 1.3-1.7 g Zn/kg rice seed.

3. A composition according to claim 1, wherein the composition further comprises a pesticidal active ingredient.

4. A composition according to claim 3, wherein the pesticidal active ingredient is at least one compound selected from the group consisting of thiamethoxam, clothianidin, imidacloprid, acetamiprid, dinotefuran, nitenpyram, thiacloprid, thiodicarb, aldicarb, carbofuran, furadan, fenoxycarb, carbaryl, sevin, ethienocarb, fenobucarb, chlorantraniliprole, cyantraniliprole, flubendiamide, spinosad, spinetoram, lambda-cyhalothrin, gamma-cyhalothrin, tefluthrin, fipronil, sulfoxaflor, azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M, sedaxane, penflufen, abamectin, aldicarb, thiadicarb, carbofuran, carbosulfan, oxamyl, aldoxycarb, ethoprop, methomyl, benomyl, alanycarb, iprodione, phenamiphos (fenamiphos), fensulfothion, terbufos, fosthiazate, dimethoate, phosphocarb, dichlofenthion, isamidofos, fosthietan, isazofos ethoprophos, cadusafos, terbufos, chlorpyrifos, dichlofenthion, heterophos, isamidofos, mecarphon, phorate, thionazin, triazophos, diamidafos, fosthietan, phosphamidon, imicyafos, captan, thiophanate-methyl and thiabendazole.

5. A composition according to claim 4, wherein the pesticidal active ingredient is a combination of thiamethoxam, fludioxonil, azoxystrobin, metalaxyl-M and sedaxane.

6. A method of improving the growing characteristics of rice, comprising:
applying ZnEDTA to rice seeds at a rate of 1-2 g Zn/kg rice seed; and
sowing the seeds, wherein the rate is not 1.40 g Zn/kg rice seed.

7. A method according to claim 6, wherein the rice seeds are sown in zinc-deficient soil.

8. A method according to claim 6, further comprising applying at least one pesticidal active ingredient to the rice seeds prior to the sowing step.

9. A method according to any of claims 6 to 8, wherein at least one compound selected from the group consisting of thiamethoxam, clothianidin, imidacloprid, acetamiprid, dinotefuran, nitenpyram, thiacloprid, thiodicarb, aldicarb, carbofuran, furadan, fenoxycarb, carbaryl, sevin, ethienocarb, fenobucarb, chlorantraniliprole, cyantraniliprole, flubendiamide, spinosad, spinetoram, lambda-cyhalothrin, gamma-cyhalothrin, tefluthrin, fipronil, sulfoxaflor, azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M, sedaxane, penflufen, abamectin, aldicarb, thiadicarb, carbofuran, carbosulfan, oxamyl, aldoxycarb, ethoprop, methomyl, benomyl, alanycarb, iprodione, phenamiphos (fenamiphos), fensulfothion, terbufos, fosthiazate, dimethoate, phosphocarb, dichlofenthion, isamidofos, fosthietan, isazofos ethoprophos, cadusafos, terbufos, chlorpyrifos, dichlofenthion, heterophos, isamidofos, mecarphon, phorate, thionazin, triazophos, diamidafos, fosthietan, phosphamidon, imicyafos, captan, thiophanate-methyl and thiabendazole is applied to the rice seeds.

10. A method according to claim 9, wherein at least two of thiamethoxam, fludioxonil, azoxystrobin, metalaxyl-M and sedaxane is applied to the rice seeds.

11. A rice seed comprising ZnEDTA at a rate of from 1 to 2 g Zn/kg rice seed, wherein the rate is not 1.40 g Zn/kg rice seed.

12. A rice seed according to claim 11, further comprising at least one compound selected from the group consisting of thiamethoxam, fludioxonil, azoxystrobin, metalaxyl-M and sedaxane.
